(19) United States
(12) Patent Application Publication
(10) Pub. No.: US 2026/0369909 A1
(43) Pub. Date: Nov. 19, 2026

(54) CONNECTOR MODULE AND CONNECTOR

(71) Applicant: Tyco Electronics (Shanghai) Co., Ltd., Shanghai (CN)

(72) Inventors: Hongwen (Jason SH) Yang, Shanghai (CN); Guangming (Suny) Zhao, Shanghai (CN); WenYu (Vindy) Liu, Shanghai (CN)

(73) Assignee: Tyco Electronics (Shanghai) Co., Ltd., Shanghai (CN)

(21) Appl. No.: 19/680,262

(22) Filed: May 18, 2026

(30) Foreign Application Priority Data
May 19, 2025 (CN) 202510645243.9

(51) Int. Cl. H01R 12/85; H01R 12/72

(52) U.S. Cl. CPC H01R 12/85; H01R 12/721

(57) ABSTRACT

A connector module includes an insulator having opposite front and rear sides, two rows of terminals installed on the insulator and facing each other, and a preloading member. Each terminal in the two rows of terminals has an elastic cantilever each having an electrical contact part. The preloading member is movably mounted on the insulator and located between each elastic cantilever. The preloading member is movable from a preloading position to a release position by a mating electrical board inserted between each elastic cantilever. In the preloading position, the preloading member expands each elastic cantilever outward to increase a distance between each electrical contact part and apply a preloading force on each elastic cantilever. When pushed to the release position by the mating electrical board, the preloading member separates from each elastic cantilever, and each elastic cantilever is released and applies a predetermined contact force on the mating electrical board.

### CROSS-REFERENCE TO RELATED APPLICATION

This application claims the benefit of the filing date under 35 U.S.C. § 119(a)-(d) of Chinese Patent Application No. CN202510645243.9 filed on May 19, 2025, the whole disclosure of which is incorporated herein by reference.

### Field of the Invention

The present invention relates to a connector module and, more particularly, to a connector module and a connector comprising the connector module.

### Background of the Invetion

A connector typically includes upper and lower rows of terminals arranged in the housing. The terminal has an elastic cantilever with an electrical contact part located at its end, which is used for electrical contact with a mating electrical board inserted between the elastic cantilevers of two rows of terminals. Typically, in order to guide the mating electrical board to be inserted between the elastic cantilevers of the two rows of terminals, the terminals have residual end parts that extend obliquely from the electrical contact part. The residual end parts of the two rows of terminals define an outward flared guide entrance to guide the mating electrical board to be smoothly inserted between the elastic cantilevers of the two rows of terminals. Typically, the length of the residual end part of the terminal is relatively large, which can lead to impedance low points and high-frequency resonance of insertion loss at the contact interface of the connector, which can reduce the signal integrity of the connector.

### SUMMARY OF THE INVENTION

A connector module includes an insulator having opposite front and rear sides, two rows of terminals installed on the insulator and facing each other, and a preloading member. Each terminal in the two rows of terminals has an elastic cantilever each having an electrical contact part. The preloading member is movably mounted on the insulator and located between each elastic cantilever. The preloading member is movable from a preloading position to a release position by a mating electrical board inserted between each elastic cantilever. In the preloading position, the preloading member expands each elastic cantilever outward to increase a distance between each electrical contact part and apply a preloading force on each elastic cantilever. When pushed to the release position by the mating electrical board, the preloading member separates from each elastic cantilever, and each elastic cantilever is released and applies a predetermined contact force on the mating electrical board.

### BRIEF DESCRIPTION OF DRAWINGS

The invention will now be described by way of example with reference to the accompanying figures, of which:

FIG. 1 is a perspective view of a connector module according to an exemplary embodiment;

FIG. 2 is an exploded view of the connector module of FIG. 1;

FIG. 3 is another exploded view of the connector module of FIG. 1;

FIG. 4 is another exploded view of the connector module of FIG. 1;

FIG. 5 is a longitudinal sectional view of the connector module of FIG. 1;

FIG. 6 is a plan sectional view of the connector module of FIG. 1;

FIG. 7 is a perspective view of the connector module of FIG. 1 and a mating electrical board according to an exemplary embodiment;

FIG. 8 is a plan sectional view of the connector module of FIG. 1 and the mating electrical board of FIG. 7, where the mating electrical board has not yet been inserted and a preloading member is in a preloading position;

FIG. 9 is a plan sectional view of the connector module of FIG. 1 and the mating electrical board of FIG. 7, where the mating electrical board has not yet been inserted and the preloading member of FIG. 8 is in a released position;

FIG. 10 is a plan sectional view of the connector module of FIG. 1 and the mating electrical board of FIG. 7, with the preloading member of FIG. 8 in the released position of FIG. 9;

FIG. 11 is a plan sectional view of the connector module of FIG. 1 and the mating electrical board of FIG. 7, where the preloading member of FIG. 8 has been pushed to the release position of FIG. 9 by the mating electrical board; and

FIG. 12 is an exploded view of a connector module according to another exemplary embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

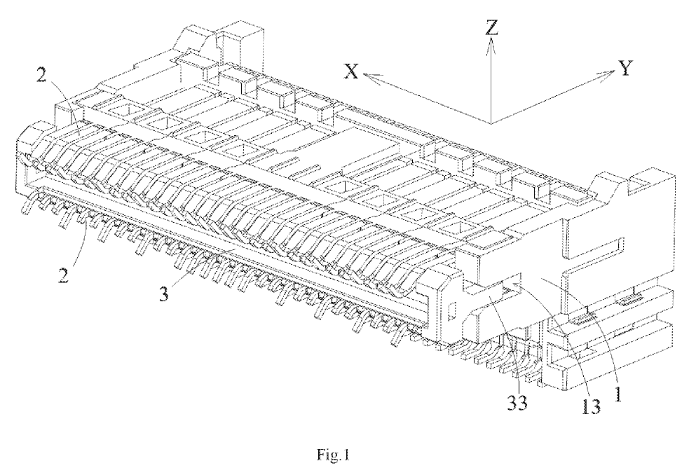

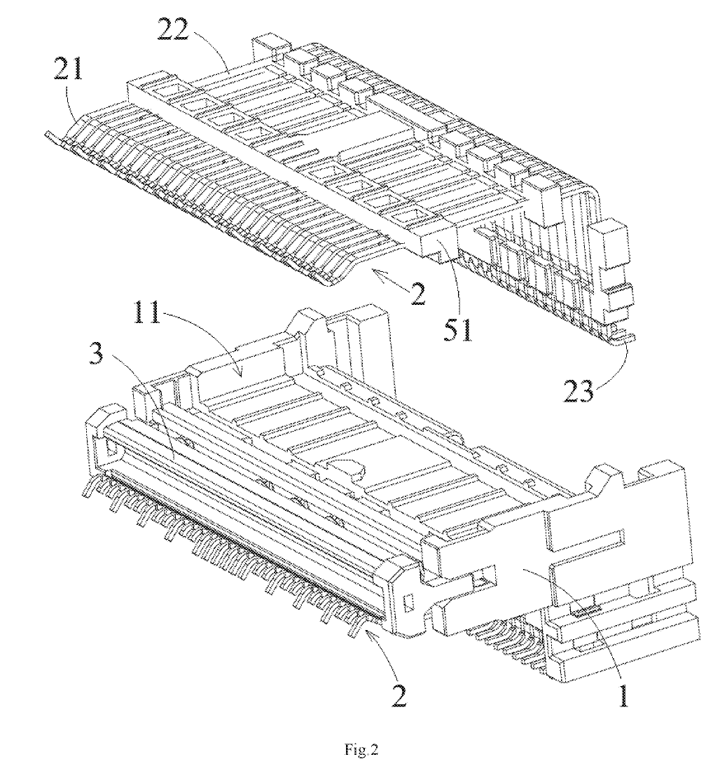

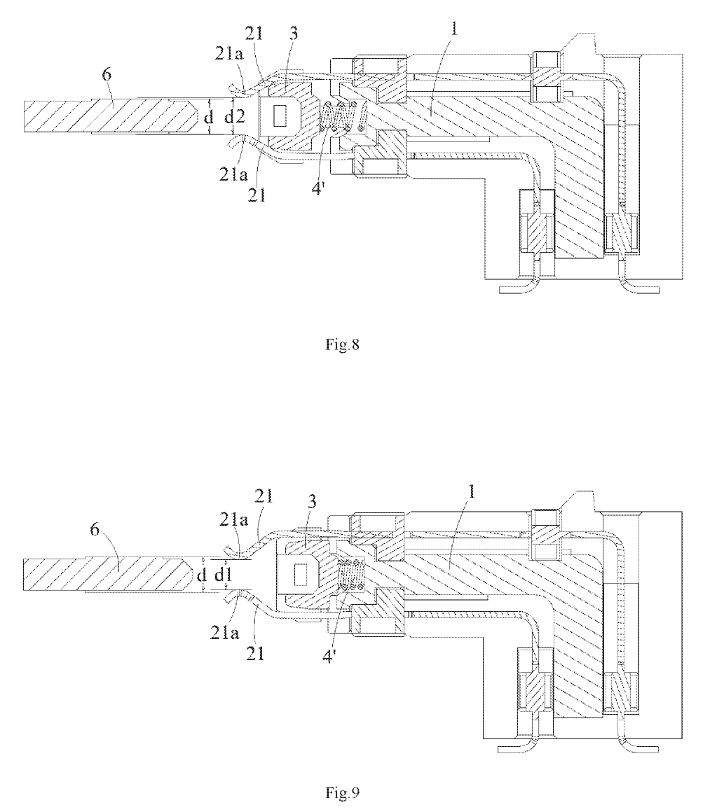

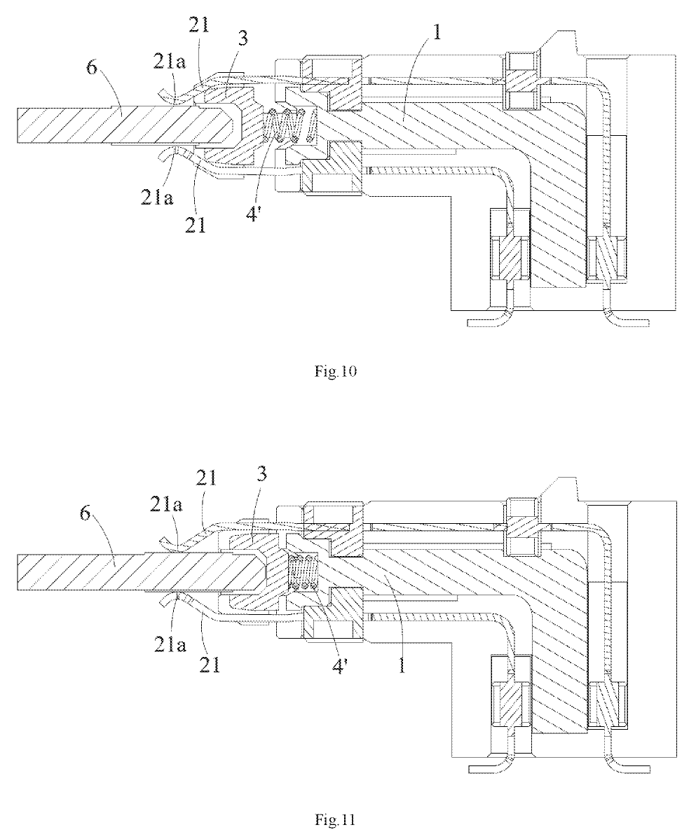

An exemplary embodiment of a connector module will now be described with reference to FIGS. 1-11. As shown in FIGS. 1-2 and 5, the connector module includes an insulator 1, two rows of terminals 2, and a preloading member 3. The insulator 1 has front and rear sides that are opposite in a longitudinal direction Y. The two rows of terminals 2 are installed on the insulator 1 and face each other in the height direction Z, with each terminal 2 having an elastic cantilever 21, as shown in FIGS. 2-3 and 5-11, extending from the front side of the insulator 1.

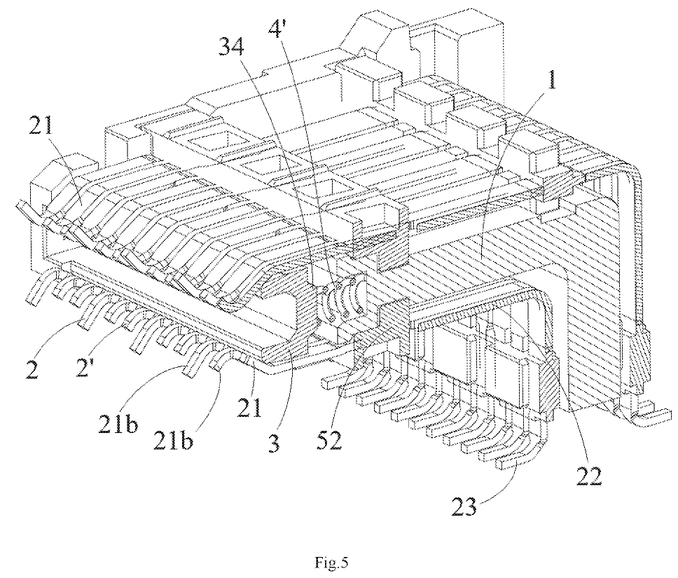

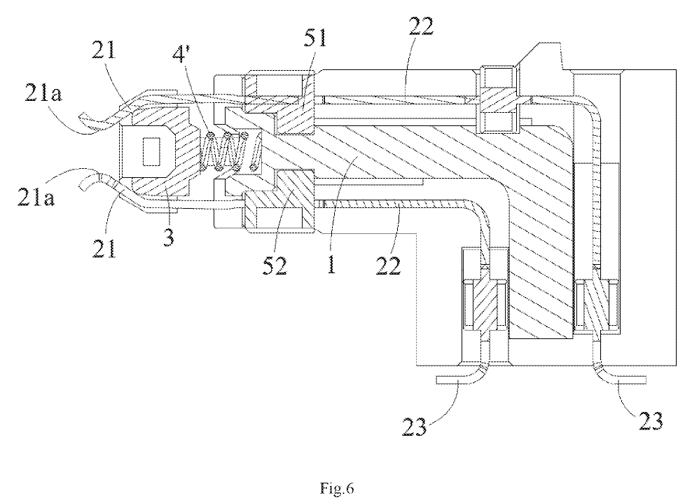

The preloading member 3 is mounted on the insulator 1 in a movable manner and, as shown in FIGS. 5-6 and 8-11, located between the elastic cantilevers 21 of two rows of terminals 2. The preloading member 3 can move from a preloading position to a release position along the longitudinal direction Y under the push of the mating electrical board 6 inserted between the elastic cantilevers 21 of the two rows of terminals 2. The elastic cantilever 21 has an electrical contact part 21a, as shown in FIGS. 6 and 8-11, located at its end for electrical contact with the mating electrical board 6. When in the preloading position, the preloading member 3 expands the elastic cantilevers 21 of the two rows of terminals 2 outward to increase the spacing between the electrical contact parts 21a of the two rows of terminals 2 and apply a preloading force on the elastic cantilevers 21 of the two rows of terminals 2. When pushed to the release position by the mating electrical board 6, the preloading member 3 separates from the elastic cantilevers 21 of the two rows of terminals 2, and the elastic cantilever 21 is released and applies a predetermined contact force on the mating electrical board 6 to ensure reliable electrical contact between the electrical contact part 21a and the mating electrical board 6.

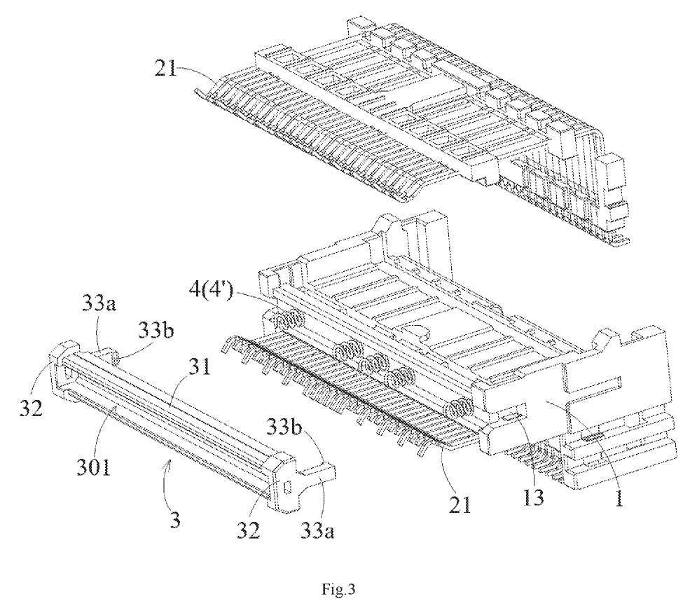

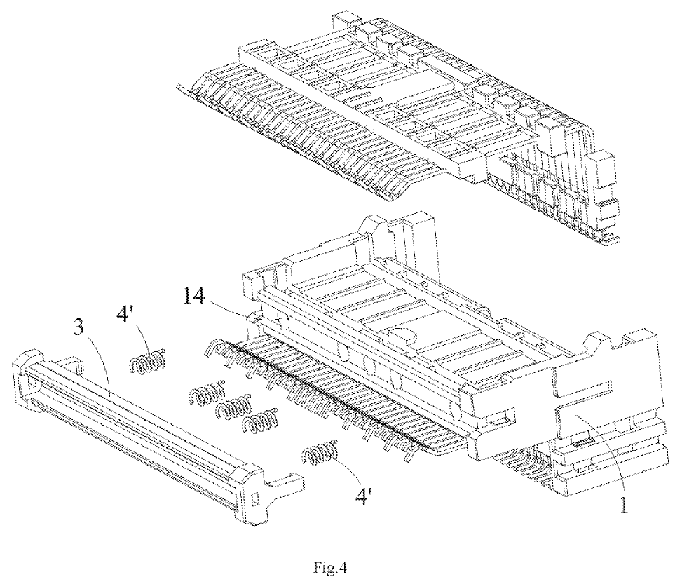

As shown in FIG. 3, the connector module further comprises an elastic component 4. The elastic component 4 is clamped between the preloading member 3 and the insulator 1 for resetting the preloading member 3 from the release position to the preloading position. As shown in FIGS. 3-4, the elastic component 4 is a coil spring 4’, and the connector module includes multiple coil springs 4’ spaced apart in the transverse direction X. The multiple coil springs 4’ are axially compressed between the preloading member 3 and the insulator 1.

As shown in FIG. 4, multiple positioning blind holes 14 are formed in the front side of the insulator 1. The rear ends of multiple coil springs 4’ are respectively installed and positioned in the multiple positioning blind holes 14.

As shown in FIG. 1, a hook 33 is formed on the preloading member 3, and a snap slot 13 is formed on the insulator 1. The hook 33 is movably engaged with the snap slot 13 to allow the preloading member 3 to move relative to the insulator 1 between the preloading position and the release position but cannot detach from the insulator 1.

As shown in FIG. 3, the preloading member 3 has a main body 31 extending along the transverse direction X and two end parts 32 connected to the two ends of the main body 31. The main body 31 of the preloading member 3 is located between the elastic cantilevers 21 of the two rows of terminals 2, and the hook 33 is formed on the end part 32 of the preloading member 3. The hook 33, as shown in FIG. 3, includes a cantilever part 33a extending along the longitudinal direction Y and a protrusion part 33b formed at the end of the cantilever part 33a. The snap slot 13 extends along the longitudinal direction Y and is slidably engaged with the protrusion part 33b of the hook 33, allowing the protrusion part 33b of the hook 33 to move along the longitudinal direction Y in the snap slot 13.

As shown in FIG. 3, the preloading member 3 has front and rear sides that are opposite in the longitudinal direction Y. A positioning groove 301 is formed on the front side of the preloading member 3, which extends along the transverse direction X and is used to position and accommodate the front end of the mating electrical board 6.

As shown in FIG. 5, a strip-shaped protrusion 34 extending along the transverse direction X is formed on the rear side of the preloading member 3. The strip-shaped protrusion 34 is used to rest against the elastic component 4.

As shown in FIGS. 2 and 5-6, the terminal 2 also has an L-shaped fixing part 22 and a soldering foot 23. The L-shaped fixing part 22 is connected between the elastic cantilever 21 and the soldering foot 23. The soldering foot 23 is exposed from the bottom of the insulator 1 for soldering to a circuit board.

As shown in FIGS. 2 and 6, the connector module further includes an upper injection molded body 51, which is injected onto the L-shaped fixing parts 22 of the upper row of terminals 2 in the two rows of terminals 2, so that the upper row of terminals 2 and the upper injection molded body 51 are formed as a single piece. An upper mounting slot 11 is formed on the insulator 1, and the upper injection molded body 51 and the upper row of terminals 2 are assembled into the upper mounting slot 11 of the insulator 1.

As shown in FIGS. 5-6, the connector module further includes a lower injection molded body 52, which is injected onto the L-shaped fixing parts 22 of the lower row of terminals 2 in the two rows of terminals 2, so that the lower row of terminals 2 and the lower injection molded body 52 are formed as a single piece. A lower mounting slot is formed on the insulator 1, and the lower injection molded body 52 and the lower row of terminals 2 are assembled into the lower mounting slot of the insulator 1.

As shown in FIG. 5, the elastic cantilever 21 of the terminal 2 also has a residual end part (or referred to as sticking) 21b extending from the electrical contact part 21a. The two rows of terminals 2 include multiple pairs of differential signal terminals 2’, and the length of the residual end part 21b of the differential signal terminal 2’ is smaller than the length of the residual end part 21b of the other terminals 2 except for the differential signal terminals 2’ in the two rows of terminals 2.

When the preloading member 3 is in the release position and the mating electrical board 6 is not inserted between the elastic cantilevers 21 of the two rows of terminals 2, the distance between the electrical contact parts 21a of the two rows of terminals 2 is equal to a first distance d1. The first distance d1 is smaller than the thickness d of the mating electrical board 6. When the preloading member 3 is in the preloading position, the distance between the electrical contact parts 21a of the two rows of terminals 2 is expanded by the preloading member 3 to a second distance d2 greater than the first distance d1.

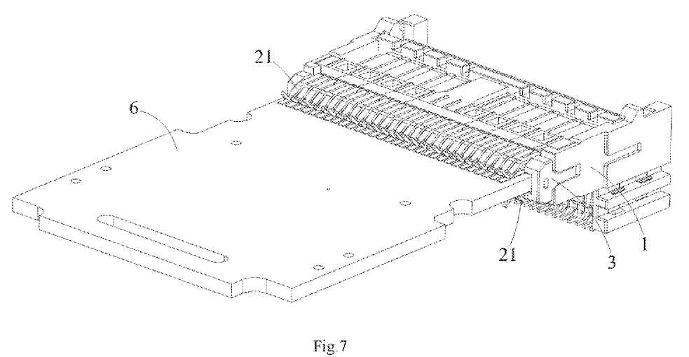

As shown in FIG. 8, the second distance d2 can be equal to, slightly larger than, or slightly smaller than the thickness d of the mating electrical board 6 to reduce the insertion force of the mating electrical board 6 inserted between the elastic cantilevers 21 of the two rows of terminals 2.

The preloading member 3 can increase the spacing between the electrical contact parts 21a of the upper and lower rows of terminals 2, so that the mating electrical board 6 can be smoothly inserted into the electrical contact parts 21a of the two rows of terminals 2 without the guidance of the residual end parts 21b of the terminals 2. Therefore, the present invention can shorten or remove the residual end part 21b of the differential signal terminal 2’, effectively avoiding the impedance low point and insertion loss high-frequency resonance problems at the connector contact interface, and improving the signal integrity of the connector.

Further, shortening the length of the residual end part 21b at the head of the terminal 2 can reduce the parasitic capacitance and inductance of the residual end part 21b, making the impedance closer to the target value, thereby improving impedance matching, reducing signal reflection, and improving signal transmission quality. By shortening the length of the residual end part 21b, the resonant frequency can be changed to move it away from the frequency band of signal transmission, or the amplitude of resonance can be reduced, effectively suppressing high-frequency resonance, reducing insertion loss, and meeting the requirements of signal transmission efficiency for 224G applications.

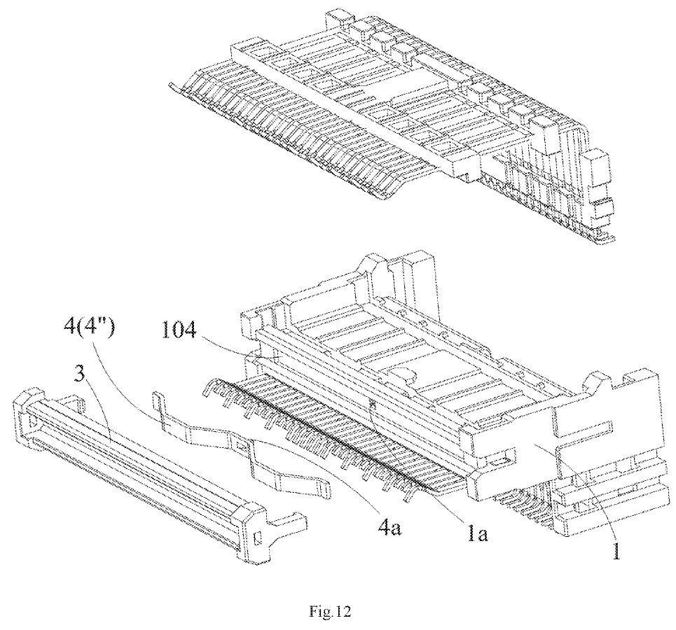

Another exemplary embodiment of a connector module will now be describe with reference to FIG. 12. The only difference between the connector module according to FIG. 12 and the connector module according to FIGS. 1-11 is the elastic component 4.

As shown in FIG. 12, the elastic component 4 is a wavy spring piece 4”, and the connector module includes a single wavy spring piece 4”, which is compressed along the longitudinal direction Y between the preloading member 3 and the insulator 1.

As shown in FIG. 12, a receiving groove 104 extending along the transverse direction X is formed on the front side of the insulator 1, and the wavy spring piece 4” is received and installed in the receiving groove 104 of the insulator 1. An elastic buckle 4a is formed on the wavy spring piece 4”, and a joint hole 1a is formed in the insulator 1. The elastic buckle 4a is inserted and joined into the joint hole 1a to join the wavy spring piece 4” to the insulator 1.

Except for the aforementioned differences, the other technical features of the connector module according to FIG. 12 are basically the same as those of the connector module according to FIGS. 1-11, which can be referred to as the connector module shown in FIGS. 1-11.

An exemplary embodiment of a connector will now be descried with reference to FIGS. 1-12. The connector includes a housing and a connector module as shown in FIGS. 1-12. The connector module is installed into the housing.

In the aforementioned exemplary embodiments according to the present invention, the preloading member 3 can increase the distance between the electrical contact parts 21a of the upper and lower rows of terminals 2, allowing the mating electrical board 6 to be smoothly inserted between the electrical contact parts 21a of the two rows of terminals 2 without the need for guidance from the residual end parts 21b of the terminals 2. Therefore, the present invention can shorten or remove the residual end part 21b of the differential signal terminal 2’, effectively avoiding the impedance low point and insertion loss high-frequency resonance problems at the connector contact interface, and improving the signal integrity of the connector.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector module, comprising:
an insulator having a front side and a rear side opposite in a longitudinal direction;
two rows of terminals installed on the insulator and facing each other in a height direction, each terminal in the two rows of terminals has an elastic cantilever extending from the front side of the insulator; and
a preloading member movably mounted on the insulator and located between each elastic cantilever, the preloading member is movable along the longitudinal direction from a preloading position to a release position by a mating electrical board inserted between each elastic cantilever, each elastic cantilever has an electrical contact part located at its end for electrical contact with the mating electrical board, when in the preloading position, the preloading member expands each elastic cantilever outward to increase a distance between the electrical contact part of the elastic cantilever of each terminal in one of the two rows of terminals from the electrical contact part of the elastic cantilever of each terminal in an other of the two rows of terminals and apply a preloading force on each elastic cantilever, when pushed to the release position by the mating electrical board, the preloading member separates from each elastic cantilever, and each elastic cantilever is released and applies a predetermined contact force on the mating electrical board to ensure electrical contact between the electrical contact part of each elastic cantilever and the mating electrical board.

2. The connector module of claim 1, further comprising an elastic component clamped between the preloading member and the insulator for resetting the preloading member from the release position to the preloading position.

3. The connector module of claim 2, wherein the elastic component is a coil spring, and the connector module has a plurality of coil springs spaced apart in a transverse direction, the coil springs are axially compressed between the preloading member and the insulator.

4. The connector module of claim 3, wherein a plurality of positioning blind holes are formed in the front side of the insulator, rear ends of the coil springs are respectively installed and positioned in the blind holes.

5. The connector module of claim 2, wherein the elastic component is a wavy spring piece, and the connector module has a single wavy spring piece that is compressed along the longitudinal direction between the preloading member and the insulator.

6. The connector module of claim 5, wherein a receiving groove extending along a transverse direction is formed on the front side of the insulator, the wavy spring piece is accommodated and installed in the receiving groove of the insulator.

7. The connector module of claim 5, wherein an elastic buckle is formed on the wavy spring piece, and a joint hole is formed in the insulator, the elastic buckle is inserted and joined into the joint hole to join the wavy spring piece to the insulator.

8. The connector module of claim 5, wherein the wavy spring piece has a wave shape.

9. The connector module of claim 2, wherein a hook is formed on the preloading member, a snap slot is formed on the insulator, the preloading member cannot detach from the insulator, and the hook is movably engaged with the snap slot to allow the preloading member to move relative to the insulator between the preloading position and the release position.

10. The connector module of claim 9, wherein the preloading member has a main body extending along a transverse direction and two end parts respectively connected to both ends of the main body, the main body of the preloading member is located between each elastic cantilever, and the hook is formed on one end part of the preloading member.

11. The connector module of claim 10, wherein the hook has a cantilever part extending along the longitudinal direction and a protrusion formed at the end of the cantilever part, the snap slot extends along the longitudinal direction and is slidably engaged with the protrusion of the hook, allowing the protrusion of the hook to move along the longitudinal direction in the snap slot.

12. The connector module of claim 10, wherein the preloading member has a front side and a rear side that are opposite in the longitudinal direction, and a positioning groove is formed on the front side of the preloading member, the positioning groove extends along the transverse direction for positioning and accommodating a front end of the mating electrical board.

13. The connector module of claim 12, wherein a strip-shaped protrusion extending along the transverse direction is formed on the rear side of the preloading member, the strip-shaped protrusion rests on the elastic component.

14. The connector module of claim 1, wherein each terminal has a soldering foot and an L-shaped fixing part connected between the elastic cantilever and the soldering foot, each soldering foot is exposed from a bottom of the insulator for soldering to a circuit board.

15. The connector module of claim 14, further comprising an upper injection molded body injected onto the L-shaped fixing parts of each terminal of an upper row of terminals in the two rows of terminals, such that the upper row of terminals and the upper injection molded body are formed as a single piece, an upper mounting slot is formed on the insulator, the upper injection molded body and the upper row of terminals are assembled into the upper mounting slot of the insulator.

16. The connector module of claim 14, further comprising a lower injection molded body injected onto the L-shaped fixing parts of each terminal of a lower row of terminals in the two rows of terminals, such that the lower row of terminals and the lower injection molded body are formed as a single piece, a lower mounting slot is formed on the insulator, the lower injection molded body and the lower row of terminals are assembled into the lower mounting slot of the insulator.

17. The connector module of claim 1, wherein each elastic cantilever has a residual end part extending from the electrical contact part, and the two rows of terminals include a plurality of pairs of differential signal terminals, a length of the residual end part of each differential signal terminal is smaller than a length of the residual end part of other terminals in the two rows of terminals.

18. The connector module of claim 1, wherein when the preloading member is in the release position and the mating electrical board is not inserted between each elastic cantilever, the distance between the electrical contact part of the elastic cantilever of each terminal in the one row of terminals and the electrical contact part of the elastic cantilever of each terminal in the other row of terminals is equal to a first distance, the first distance is smaller than a thickness of the mating electrical board, and when the preloading member is in the preloading position, the distance between the electrical contact part of the elastic cantilever of each terminal in the one row of terminals and the electrical contact part of the elastic cantilever of each terminal in the other row of terminals is expanded by the preloading member to a second distance greater than the first distance.

19. The connector module of claim 18, wherein the second distance is greater than the thickness of the mating electrical board to reduce an insertion force of the mating electrical board inserted between each elastic cantilever.

20. A connector, comprising:
a housing; and
a connector module, including an insulator, two rows of terminals, and a preloading member, the insulator has a front side and a rear side opposite in a longitudinal direction, the two rows of terminals are installed on the insulator and face each other in a height direction, each terminal in the two rows of terminals has an elastic cantilever extending from the front side of the insulator, the preloading member is movably mounted on the insulator and is located between each elastic cantilever, the preloading member is movable along the longitudinal direction from a preloading position to a release position by a mating electrical board inserted between each elastic cantilever, each elastic cantilever has an electrical contact part located at its end for electrical contact with the mating electrical board, when in the preloading position, the preloading member
expands each elastic cantilever outward to increase a distance between the electrical contact part of the elastic cantilever of each terminal in one of the two rows of terminals from the electrical contact part of the elastic cantilever of each terminal in an other of the two rows of terminals and apply a preloading force on each elastic cantilever, when pushed to the release position by the mating electrical board, the preloading member separates from each elastic cantilever, and each elastic cantilever is released and applies a predetermined contact force on the mating electrical board to ensure electrical contact between the electrical contact part of each elastic cantilever and the mating electrical board, the connector module is installed into the housing.
